(19) United States
(12) Patent Application Publication
(10) Pub. No.: US 2025/0334161 A1
(43) Pub. Date: Oct. 30, 2025

(54) FLOCKED SPRING

(71) Applicant: CHUO HATSUJO KABUSHIKI KAISHA, Nagoya-shi, Aichi (JP)

(72) Inventor: Yasuhiko KUNITA, Nagoya-shi, Aichi (JP)

(73) Assignee: CHUO HATSUJO KABUSHIKI KAISHA, Nagoya-shi, Aichi (JP)

(21) Appl. No.: 18/723,138

(22) PCT Filed: Oct. 25, 2022
(86) PCT No.: PCT/JP2022/039705

§ 371 Date: Mar. 10, 2025

(30) Foreign Application Priority Data
Dec. 22, 2021 (JP) 2021-207926

(51) Int. Cl. F16F 1/02; F16F 1/04

(52) U.S. Cl. CPC F16F 1/024; F16F 1/04

(57) ABSTRACT

A flocked spring (30) comprises: a spring body (31); a coating layer (32) arranged on the surface of the spring body (31); an adhesive layer (33) arranged on the surface of the coating layer (32); and a flocking layer (34) consisting of flocking fillers affixed to the adhesive layer (33). The adhesive layer (33) is formed of an adhesive composition containing an adhesive and a thixotropy-imparting agent. In this flocked spring (30), the thickness of the adhesive layer (33) can be increased, and the number of flocking fillers that constitute the flocking layer (34) can be increased. Consequently, the flocked spring causes less damage to a counterpart member.

### TECHNICAL FIELD

The present disclosure relates to a flocked spring having its surface subjected to flocking.

### BACKGROUND ART

For example, in a power back door or the like of an automotive vehicle, a spring assembly for automatically opening and closing the back door is arranged between the back door and the vehicle body. The spring assembly has a telescopic cylindrical shape and includes a compression coil spring between an outer cover member and an inner shaft member. When the compression coil spring is compressed, “buckling” may occur in which the coil shaft is curved in a wave or spiral shape. When the portion of the coil shaft that is radially displaced due to the buckling abuts against the cover member arranged on the outer side of the compression coil spring or against the shaft member arranged on the inner side, a hammering sound is generated. Therefore, the compression coil spring used in the spring assembly is subjected to a flocking process as a countermeasure against the hammering sound, in addition to being coated for imparting rust-prevention properties. The flocking process is a process in which an adhesive is applied in advance to the surface of an object to be processed, and short fibers are adhered thereto using an electrostatic force or the like (see, e.g., Patent Documents 1 and 2).

### PRIOR TECHNICAL DOCUMENTS

### Patent Documents

Patent Document 1: Japanese Patent Publication No. 2002-224612
Patent Document 2: Japanese Patent Publication No. H05-138813
Patent Document 3: Japanese Patent Publication No. S61-164682

### SUMMARY

### Problems to be Solved by the Invention

In the spring assembly, it is necessary to study the influence on the members related to the compression coil spring, due to the increase in the number of times of endurance required for the compression coil spring. For example, in a case where the end portion of the inner shaft member is pressed or punched, a portion that slightly protrudes outward may be formed. Although the surface of the shaft member is subjected to electrodeposition coating or the like, when the compression coil spring is brought into sliding contact with the shaft member, the coating of the protruding portion may peel off, exposing the substrate. For this reason, the compression coil spring is required to be configured so as to minimize damage to a counterpart member. For example, in the flocking process, it is possible to reduce friction with the counterpart member and reduce damage thereto by increasing the number of short fibers (fillers) to be flocked. In order to increase the number of fillers, an adhesive layer capable of affixing a large number of fillers is needed. For example, it is conceivable that the number of affixed fillers can be increased, if the adhesive layer is made thicker. However, when an attempt is made to form a thicker adhesive layer, dripping or the like occurs when the adhesive is applied. Therefore, it is not easy to thicken the adhesive layer.

The present disclosure has been made in view of such circumstances, and a subject thereof is to provide a flocked spring that causes less damage to a counterpart member.

### Means for Solving the Problems

The flocked spring of the present disclosure is characterized by comprising a spring body, a coating layer arranged on the surface of the spring body, an adhesive layer arranged on the surface of the coating layer, and a flocking layer consisting of flocking fillers affixed to the adhesive layer, wherein the adhesive layer is formed of an adhesive composition containing an adhesive and a thixotropy-imparting agent.

### Effects of the Invention

The adhesive layer constituting the flocked spring of the present disclosure is formed of an adhesive composition containing an adhesive and a thixotropy-imparting agent. The thixotropy-imparting agent is a material that imparts thixotropy to the adhesive composition. When the adhesive composition is imparted with thixotropic properties, the fluidity of the adhesive composition is exhibited through shear forces such as stirring during preparation and application of the adhesive composition, and on the other hand, after application, the viscosity increases, the fluidity is reduced, and dripping is suppressed. Hence, the thickness of the formed adhesive layer can be increased, and the number of flocking fillers affixed to the adhesive layer, that is, the number of flocking fillers constituting the flocking layer can be increased. Furthermore, according to the studies of the present inventor, it has also been confirmed that the number of flocking fillers affixed in a nearly upright state to the surface of the adhesive layer is increased. Thus, according to the flocked spring of the present disclosure, the thickness of the adhesive layer can be increased to achieve a desired flocked state, hence friction with a counterpart member can be reduced, and damage to the counterpart member can be decreased.

Incidentally, in Patent Document 3, as a method for finishing the interior of an automotive vehicle body, a method is described in which the interior of the vehicle body is subjected to electrodeposition coating and it is baked to form an electrodeposition coating film, and then a synthetic resin adhesive is applied, and it is used as a counter electrode and electrostatically flocked with short fibers. Further, it is described that the adhesive used in electrostatic flocking may contain an anti-sagging agent in addition to the adhesive synthetic resin component. However, the electrostatic flocking described in Patent Document 3 is intended for finishing the interior of the vehicle body, and it is not assumed that the flocking layer will be brought into contact with a counterpart member. Therefore, Patent Document 3 does not consider the thickness of the adhesive layer or the implanted state of the flocking filler, nor does it describe or suggest increasing the thickness of the adhesive layer.

### BRIEF DESCRIPTION OF DRAWINGS

FIG. 1 is a partial schematic diagram of a spring assembly comprising a compression coil spring according to one embodiment of a flocked spring of the present disclosure.

FIG. 2 is a radial cross-sectional view of a bare wire of the same compression coil spring.

FIG. 3 is a schematic diagram of a implanted state of a flocking filler for explaining an upright filler in the present disclosure, wherein (a) shows a vertical state and (b) shows an inclined state.

FIG. 4 is a graph showing the thicknesses of adhesive layers formed using adhesive compositions with and without a thixotropy-imparting agent.

FIG. 5 is a graph showing the results of measurement of abrasion amounts in abrasion tests.

FIG. 6 is a graph plotting the number of fillers in relation to the thickness of an adhesive layer.

FIG. 7 is a graph plotting the number of upright fillers in relation to the thickness of the adhesive layer.

FIG. 8 is a graph plotting the inclination ratio of the fillers in relation to the thickness of the adhesive layer.

### DETAILED DESCRIPTION OF EMBODIMENTS

### Flocked Spring

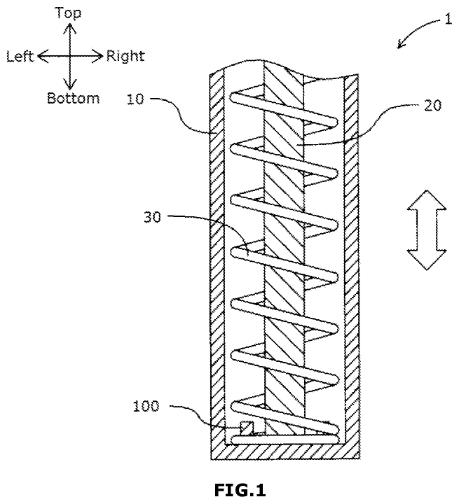

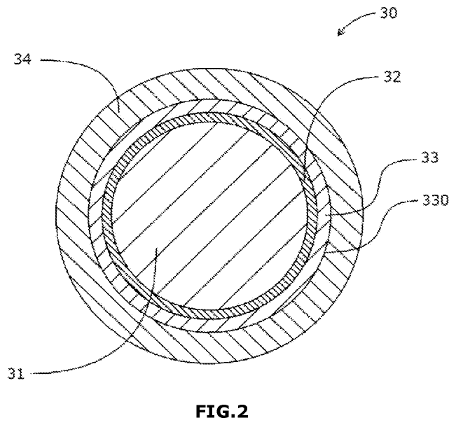

As one embodiment of the flocked spring of the present disclosure, a form used as a compression coil spring constituting a spring assembly is described. First, the structures of the spring assembly and the compression coil spring of this embodiment are described. FIG. 1 shows a partial schematic diagram of the spring assembly. FIG. 2 shows a radial cross-sectional view of a bare wire of the compression coil spring housed in the same spring assembly. As shown in FIG. 1, the spring assembly 1 comprises a cover member 10, a guide member 20, and a compression coil spring 30. The spring assembly 1 is used for a flip-up-type power back door of a vehicle.

The cover member 10 is made of polyamide resin and has a bottomed cylindrical shape with an upward opening. A spring seat 100 is arranged on the upper surface of the bottom wall of the cover member 10. A lower end of the cover member 10 is swingably mounted to a back door (not shown) of a vehicle. The guide member 20 has a cylindrical shape and is disposed to protrude upward from the upper surface of the bottom wall of the cover member 10. The guide member 20 is arranged on the inner side of the spring seat 100. The guide member 20 is made of iron and has a surface coated by cationic electrodeposition. The compression coil spring 30 is housed inside the cover member 10. The compression coil spring 30 is arranged around the guide member 20 as a shaft, and a lower end coil portion is mounted around the spring seat 100. The compression coil spring 30 repeats stretching and contraction in the upward/downward direction according to the operations of opening and closing of the back door.

As shown in FIG. 2, the compression coil spring 30 has a spring body 31, a coating layer 32, an adhesive layer 33, and a flocking layer 34 in the radially expanding direction. The spring body 31 is made of spring steel, and has a zinc phosphate film formed on its surface. The coating layer 32 is arranged on the surface of the spring body 31. The coating layer 32 contains a modified epoxy ester resin and a melamine resin as resins of a coating film-forming component. The coating layer 32 has a thickness of 25 μm. The adhesive layer 33 is arranged on the surface of the coating layer 32. The adhesive layer 33 is formed of an adhesive composition comprising an adhesive containing a modified epoxy resin and an antirust pigment, and a thixotropy-imparting agent containing amorphous silica. The adhesive layer 33 has a thickness of about 41 μm. Since flocking fillers are affixed to the adhesive layer 33, the thickness of the adhesive layer 33 is not constant under the influence of the flocking fillers. The surface 330 of the adhesive layer 33 has a pencil hardness of 3 H.

The flocking layer 34 is arranged on the surface 330 of the adhesive layer 33. The flocking layer 34 consists of flocking fillers made of nylon 66 fibers. The flocking filler has a length of 800 μm, part of which is embedded in the adhesive layer 33 and the other part of which protrudes outward from the adhesive layer 33. The flocking layer 34 is formed by the other part of the flocking fillers that protrude from the adhesive layer 33. On the surface 330 of the adhesive layer 33, there are 76 flocking fillers affixed in an arbitrary range of 1.2 mm^{2,} among which there are 60 upright fillers affixed in an approximately upright state (from a state perpendicular to the surface 330 of the adhesive layer 33 to a state inclined at an angle of 45°), and there are 16 other inclined fillers. In this case, the inclination ratio of the flocking fillers (the ratio of inclined fillers) in the flocking layer 34 is 21%. The compression coil spring 30 is included in the concept of the flocked spring of the present disclosure.

Next, the functions and effects of the compression coil spring of this embodiment is described. According to this embodiment, the adhesive layer 33 is formed of an adhesive composition containing an adhesive and a thixotropy-imparting agent. Due to the action of the thixotropy-imparting agent, when the adhesive composition is applied, the viscosity increases and the fluidity decreases, thus dripping is suppressed. Hence, the thickness of the formed adhesive layer 33 can be increased, and a large number of flocking fillers can be affixed to the adhesive layer 33. In addition, there is a great number of upright fillers in the flocking layer 34. Therefore, according to the compression coil spring 30, friction with the guide member 20 can be reduced, and the guide member 20 is less likely to suffer from damage such as peeling of coating.

An embodiment of the flocked spring of the present disclosure has been described above, but the flocked spring of the present disclosure is not limited to this embodiment, and can be embodied in various forms in which modifications, improvements, and the like that can be made by those skilled in the art are implemented without departing from the gist of the present disclosure.

### Spring Body

The type of the spring body is not particularly limited to a coil spring, a plate spring, a spiral spring, a torsion bar, or the like. Spring steel, which is used for springs, is generally preferable as the material of the spring body, and examples thereof include carbon steel, alloy steel, stainless steel, and the like. In the spring body, for example, after hot or cold forming of spring steel or the like, shot peening or the like may be carried out to preadjust the surface roughness. Further, it is preferred to form a film of phosphate such as zinc phosphate or iron phosphate or the like on the substrate surface of the spring body. By forming a coating layer on the phosphate film, the corrosion resistance is improved and the adhesion of the coating layer is also improved. In particular, in a case where the phosphate is zinc phosphate, the corrosion resistance is further improved. The phosphate film may be formed by a well-known method. For example, examples thereof include an immersion method in which the spring body is immersed in a phosphate solution bath, and a spray method in which a phosphate solution is sprayed onto the spring body with a spray gun or the like, among others.

### Coating Layer

The coating layer is arranged on the surface of the spring body. The type of a coating material for forming the coating layer is not limited. For example, examples thereof include solvent-based coating materials, water-based coating materials, powdered coating materials, and the like. The solvent-based coating materials and the water-based coating materials (liquid coating materials) have the advantage of being easy to form thin coating films (coating layers). In addition, it is easy to form smooth coating films, and it is easy to control the film thickness. For example, equipment can be downsized by the solvent-based coating materials. According to electrodeposition coating in which the spring body is immersed in a water-based coating material and a voltage is applied using the spring body as an anode or a cathode, a chemically stable coating film with high mechanical strength can be formed. In the case of the powdered coating materials, since organic solvents are not used, the burden on the environment is small. In addition, the coating materials scatter less and can be easily collected, and can also easily form thick films, as compared to the liquid coating materials.

Any coating material may consist of a resin, a pigment, an additive, a solvent, and the like, which are base materials for forming a coating film. The resin may be selected from thermosetting resins and thermoplastic resins. Examples of the thermosetting resins include epoxy resins, polyester resins, acrylic resins, phenol resins, melamine resins, urethane resins, silicone resins, and the like. Examples of the thermoplastic resins include fluorine resins, polyethylene resins, polypropylene resins, polyvinyl chloride resins, acrylonitrile-butadiene-styrene (ABS) resins, methacrylic resins, nylon resins, and the like. From the viewpoint of enhancing rust resistance, it is desirable to select epoxy resins. Among them, a modified epoxy resin is preferable. Moreover, from the viewpoint of enhancing abrasion resistance, heat resistance, and weather resistance, it is desirable to select a melamine resin. For example, an epoxy/melamine-based coating material containing both a modified epoxy resin and a melamine resin is preferable.

The pigment includes coloring pigments, extender pigments, antirust pigments, and the like. Examples of the coloring pigments include inorganic pigments such as carbon black, titanium dioxide, bengala, and loess, and organic pigments such as quinacridone red, phthalocyanine blue, and benzidine yellow. Examples of the extender pigments include aluminum silicate, calcium carbonate, magnesium carbonate, talc, silica, barium sulfate, and the like. Examples of the antirust pigments include iron phosphate, aluminum phosphate, calcium phosphate, and the like. Examples of the additive include surface conditioners, ultraviolet absorbers, antioxidants, antistatic agents, flame retardants, and the like.

The thickness of the coating layer may be appropriately determined in consideration of the mechanical strength, antirust performance, required dimensions of the flocked spring, and the like. A thickness of 10 μm or more is preferable, and a thickness of 15 μm or more is more preferable in order to fully exhibit the desired performance. On the other hand, from the viewpoint of design robustness, a thickness of 35 μm or less is preferable, and a thickness of 25 μm or less is more preferable.

### Adhesive Layer

The adhesive layer is arranged on the surface of the coating layer. The adhesive layer is formed of an adhesive composition containing an adhesive and a thixotropy-imparting agent. The adhesive may either be of a solvent type or of an emulsion type. For example, examples thereof include adhesives containing epoxy resins, urethane resins, acrylic resins, vinyl acetate resins, polyimide resins, silicone resins, and the like as main components. The adhesive may be appropriately selected in consideration of the adhesiveness to the resin of the coating layer. Among them, a solvent-type adhesive containing a modified epoxy resin as a main component is preferable because it has high rust resistance and can be used as a one-component-type lacquer. The adhesive may contain a pigment, a solvent, and an additive, in addition to the resin component. The pigment includes coloring pigments, extender pigments, antirust pigments, and the like, similarly to the coating material for the coating layer described above. Examples of the additive include surface conditioners, ultraviolet absorbers, antioxidants, antistatic agents, flame retardants, and the like.

The thixotropy-imparting agent may be any agent capable of imparting thixotropic properties to the adhesive composition. The thixotropy-imparting agent may consist of a pigment such as amorphous silica, a resin such as amino resin, a solvent, an additive, and the like. From the viewpoint of suppressing dripping of the adhesive composition and increasing the thickness of the adhesive layer, it is desirable that the thixotropy-imparting agent is blended in an amount of 5 parts by mass or more with respect to 100 parts by mass of the adhesive. An amount of 10 parts by mass or more is preferable. On the contrary, from the viewpoint of suppressing deterioration in adhesion due to a relative decrease in the ratio of the resin component of the adhesive in the adhesive composition, it is desirable that the thixotropy-imparting agent is blended in an amount of 15 parts by mass or less with respect to 100 parts by mass of the adhesive.

The adhesive composition may contain a surface-roughening solvent, a retarder (drying retardant), and the like, in addition to the adhesive and the thixotropy-imparting agent. The surface-roughening solvent is a solvent that has the function of increasing the surface roughness of the object (coated surface) to which the adhesive composition is applied. When the coated surface has a large surface roughness, the adhesion force between the coating layer and the adhesive layer increases due to an anchoring effect, and peeling of the adhesive layer is suppressed. As a result, the flocking fillers are less likely to fall off, and the effect of reducing friction with the counterpart member is maintained. For example, in a case where the coating layer is formed by cationic electrodeposition coating, the adhesion to the adhesive layer tends to decrease because the surface is smooth. In such a case, it is effective to use a surface-roughening solvent to increase the surface roughness. In addition, when a retarder is blended, it is possible to suppress drying of the adhesive composition during the period from the application of the adhesive composition to flocking.

Flocking fillers are affixed to the adhesive layer. The thickness of the adhesive layer is not constant under the influence of the flocking fillers, and for example, after flocking, there is a portion having a thickness about 1.5 times greater than that before flocking. From the viewpoint of affixing a large number of flocking fillers by increasing the thickness of the adhesive layer, it is desirable that the adhesive layer has a thickness of 20 μm or more, or 22 μm or more, more preferably 25 μm or more before flocking, and has a thickness of 25 μm or more, or 26 μm or more, more preferably 29 μm or more after flocking. On the other hand, from the viewpoint of suppressing dripping, it is preferred that the adhesive layer has a thickness of 65 μm or less before flocking, and has a thickness of 90 μm or less, or 88 μm or less, more preferably 75 μm or less after flocking.

According to the studies of the present inventor, the surface of the adhesive layer in which the thixotropy-imparting agent is blended is harder than that in the case where no thixotropy-imparting agent is blended. If the hardness of the surface of the adhesive layer increases, it becomes less likely to be abraded during use, and the retention of the flocking fillers is improved. For example, the hardness of the surface of the adhesive layer is desirably 3 H or higher in terms of pencil hardness measured according to JIS K5600-5-4:1999 “Scratch Hardness (Pencil Method)”.

### Flocking Layer

The flocking layer consists of flocking fillers affixed to the adhesive layer. Part of the flocking filler is embedded in the adhesive layer, and the other part thereof protrudes outward from the adhesive layer. The flocking layer is formed by the other parts of the flocking fillers that protrude from the adhesive layer.

The type of the flocking fillers (hereinafter sometimes simply referred to as “filler(s)”) is not particularly limited, and may be organic fillers or inorganic fillers. Organic fillers are flexible with respect to inorganic fillers. For this reason, they are less likely to break when adhered, and the flocked state is easier to be maintained. Examples of the organic fillers include, for example, nylon fibers, polyester fibers, rayon fibers, cotton fibers, polyethylene fibers, aramid fibers, fluorine fibers, and the like. Among them, it is desirable to contain at least one type of fibers selected from nylon fibers, polyester fibers, rayon fibers, cotton fibers, and polyethylene fibers. Examples of the inorganic fillers include glass fibers and the like.

The flocking fillers may have a surface resistance value of 1×10⁵ Ω or more and less than 1×10¹⁸ Ω. In this specification, a value measured by a super megohmmeter “SM-8220” manufactured by Hioki Electric Co., Ltd. is used as the surface resistance value. In a case where the surface resistance value of the flocking fillers is less than 1×10⁵ Ω, the flying properties of the fillers deteriorate because they have high conductivity and tend to discharge. Therefore, flocking using electrostatic force becomes difficult. A more preferable surface resistance value is 1×10⁶ Ω or more. On the contrary, when the surface resistance value is 1×10¹⁸ Ω or more, the flying properties of the fillers deteriorate because they are excessively charged. Therefore, flocking using electrostatic force becomes difficult. A more preferable surface resistance value is 1×10¹³ Ω or less, more preferably 1×10¹⁰ Ω or less. In addition, if the flocking fillers are repeatedly used and dried in the flocking process, the surface resistance value increases.

Fibers, which have been subjected to various surface treatments such as electrodeposition treatment, water absorption treatment, water repellent treatment, and primer treatment for the purpose of improving dispersibility and suppressing excessive charging, are used as the flocking fillers. For example, the flocking filler preferably has an electrodeposition-treated film on its surface. With the electrodeposition-treated film, the surface resistance value of the filler is adjusted to a desired value. Hence, excessive charging of the filler is suppressed, and its flying capability during flocking is improved. In addition, since the fibers tend to agglomerate, they tend to directly get tangled and form lumps. In this respect, if the surface has an electrodeposition-treated film, the dispersibility of the fibers (flocking fillers) is improved. Hence, agglomeration of the fillers is suppressed, and a substantially uniform flocked state can be achieved.

The electrodeposition-treated film is formed by performing an electrodeposition treatment on the surface of the fiber used as the flocking filler. As the electrodeposition treatment, there is a method in which the fiber is treated with tannin, tartar emetic, or the like to generate a tannin compound or the like on the surface of the fiber. Further, there is a method in which the fiber is treated with a solution obtained by appropriately mixing inorganic salts such as barium chloride, magnesium sulfate, sodium silicate, and sodium sulfate, a quaternary ammonium salt, a higher alcohol sulfate ester salt, a betaine-type surfactant or the like, and an organic silicon compound (colloidal silica), so that a silicon-based compound is adhered to the surface of the fiber.

The flocking filler is fibrous. The length of the filler in the long-side direction is not particularly limited, but if the filler is too short, the filler will be buried in the adhesive layer and a desired flocked state is not achievable. For example, it is desirable that the length of the filler is 50 μm or more. It is more preferably 200 μm or more, further preferably 500 μm or more. On the other hand, if the filler is too long, the filler will collapse and a desired flocked state is not achievable. For example, it is desirable that the length of the filler is 2,000 μm or less. It is more preferably 1,000 μm or less, further preferably 600 μm or less. The maximum length (thickness) of the filler in the short-side direction is not particularly limited, but if the filler is too thin, it will curl under its own weight and a desired flocked state is not achievable. For example, it is desirable that the thickness of the filler is 5 μm or more. It is more preferably 10 μm or more, further preferably 20 μm or more. On the other hand, if the filler is too thick, the tactile sensation is deteriorated. For example, it is desirable that the thickness of the filler is 50 μm or less. It is more preferably 40 μm or less, further preferably 30 μm or less.

The implanted state of the flocking fillers does not necessarily have to be constant throughout the flocked spring. For example, the number of fillers may be increased for a portion which may come into contact with the counterpart member, and the number of fillers may be reduced for a portion which has no possibility to come into contact with the counterpart member. From the viewpoint of reducing friction with the counterpart member, it is preferred that the number of the flocking fillers is large. For example, in a case where a range of 1.2 mm² in the surface of the adhesive layer is set as a measurement area, the number of flocking fillers affixed to the measurement area is desirably 32 or more. It is more preferably 35 or more, further preferably 40 or more.

The flocking fillers may be implanted not only in an upright state but also in an inclined state with respect to the surface of the spring body. It is considered that when the implanted fillers intersect with one another, the amount of energy absorbed by the flocking layer increases and the sound attenuation property is improved. On the other hand, if the number of the fillers in the upright state increases, the effect of reducing friction with the counterpart member is improved, which is effective in reducing damage to the counterpart member. Therefore, from the viewpoint of reducing friction with the counterpart member, among the flocking fillers affixed to the measurement area, the number of upright fillers affixed in a substantially upright state with respect to the surface of the adhesive layer is desirably 11 or more. It is more preferably 12 or more, further preferably 16 or more.

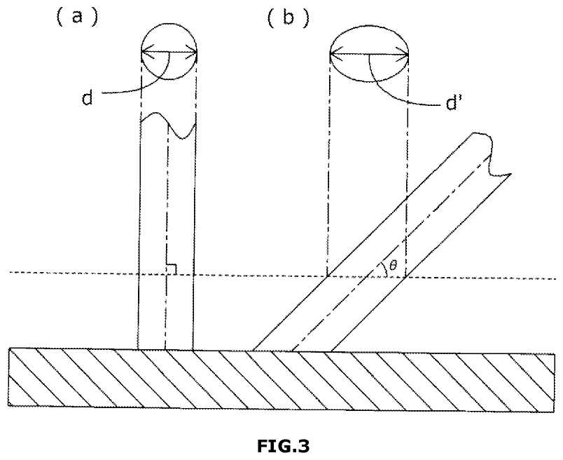

In the present disclosure, the “upright fillers affixed in a substantially upright state” means fillers affixed in a state from a state perpendicular to the surface of the adhesive layer to a state inclined at an angle of 45°. A method for identifying an upright filler is described below. FIG. 3 shows a schematic diagram of a implanted state of a flocking filler. In FIG. 3, (a) shows a vertical state, and (b) shows an inclined state. If a flocking filler having a circular cross section is cut along the surface of the adhesive layer as shown by the dotted line in FIG. 3, the cross section becomes an elliptical shape in the case of inclination. As shown in FIG. 3(b), if the angle of the inclined filler relative to the adhesive layer is set as θ, the relationship between the length d′ of the major axis of the cross section of the inclined filler and the diameter d of the non-inclined filler can be represented by the following formula (I).

$${d}^{′} = d / sin θ \qquad ( I )$$

In the present disclosure, a medical scalpel was used to cut the fillers along the surface of the flocked spring, and the cross sections thereof are observed by a scanning electron microscope (SEM). Then, fillers, each having a cross section with a major axial length not more than 1.41 times the diameter (thickness) of the fillers used for flocking (equivalent to 45°≤0≤90° in the above formula (I)), are regarded as upright fillers.

Among the flocking fillers affixed to the measurement area of the surface of the adhesive layer, in a case where the fillers other than the upright fillers are regarded as inclined fillers, the ratio of the inclined fillers to the whole of the fillers can be expressed as the inclination ratio of the flocking fillers. In other words, the inclination ratio of the flocking fillers in the measurement area is calculated by the following formula (II).

$$Inclination ratio ( \% ) = the number of inclined fillers in the measurement area / the number of fillers in the measurement area \qquad ( II )$$

From the viewpoint of reducing friction with the counterpart member, it is desirable that the inclination ratio of the flocking fillers is 66% or less. It is more preferably 65% or less, further preferably 50% or less.

### Method of Producing Flocked Spring

The flocked spring of the present disclosure can be produced, for example, as follows. First, if necessary, the spring body undergoes adjustment of surface roughness by shot peening or the like, formation of a phosphate film, and the like. Next, a coating material for forming a coating layer is adhered to the spring body. As a method for adhering the coating material, a well-known method such as brush coating, a spraying method, or an immersion method may be employed depending on the type of the coating material. Subsequently, an adhesive composition is applied to the surface of the coating film. The application of the adhesive composition may be performed by brush coating, a spraying method, or the like. For example, in a case where a spraying method is employed, the spraying pressure, spraying amount, moving speed, spraying time, distance between workpieces, and the like of the spray gun may be appropriately adjusted so that the adhesive layer has a desired thickness. Then, flocking fillers are adhered to the surface to which the adhesive composition is applied. For flocking, an electrostatic coating gun, an electrostatic fluidized immersion bath, or the like may be used. Finally, the flocked spring body is heated. Heating may be performed using a commonly used electric furnace, hot air dryer, or the like. By the heating, the coating film and the applied composition are dried and solidified to form a coating layer and an adhesive layer. The heating temperature, heating time, and the like may be appropriately determined depending on the types of the coating material and the adhesive. For example, the heating temperature may be from 130 to 170° C., and the heating time may be from 10 to 40 minutes.

### EXAMPLES

Next, the present disclosure will be described more specifically by way of Examples.

### (1) Difference in Thickness of Adhesive Layer due to the Presence and Absence of a Thixotropy-Imparting Agent

The thicknesses of adhesive layers formed using adhesive compositions with and without a thixotropy-imparting agent were examined. As the base material for forming the adhesive layer, a base material was used which was obtained by forming a zinc phosphate film on a surface of a rectangular steel sheet (70 mm in length×150 mm in width, 0.8 mm in thickness) and subjecting the surface thereof to Epolamine coating. Epolamine coating was a coating using an epoxy/melamine-based coating material containing a modified epoxy ester resin and a melamine resin, and the coating material was sprayed with a spray gun at a target thickness of 25 μm. Table 1 shows the components of the epoxy/melamine-based coating material.

TABLE 1

| Epoxy/Melamine-based Coating Material | Blending Ratio (Mass %) |
|---|---|
| Modified Epoxy Ester Resin | 58.0 |
| Melamine Resin | 5.5 |
| Pigment | 1.0 |
| Additive | 4.0 |
| Solvent | 31.5 |

As the adhesive composition, two types with and without a thixotropy-imparting agent were prepared. Table 2 shows the components of the adhesive compositions used. Table 3 shows the components of the adhesive and the thixotropy-imparting agent in the adhesive compositions.

TABLE 2

| | In the Presence | In the Absence |
|---|---|---|
| Components of | of Thixotropy- | of Thixotropy- |
| Adhesive Composition | imparting Agent | imparting Agent |
| Adhesive | 100 parts by mass | 100 parts by mass |
| Surface-roughening Solvent | 30 parts by mass | 30 parts by mass |
| Retarder | 6 parts by mass | 6 parts by mass |
| Thixotropy-imparting Agent | 15 parts by mass | — |

TABLE 3

| | | Blending Ratio (mass %) |
|---|---|---|
| Adhesive | Modified Epoxy Resin | 16 |
| | Coloring Pigment, Extender | 30 |
| | Pigment, Antirust Pigment | |
| | Solvent | 53 |
| | Additive | 1 |
| Thixotropy- | Pigment (Amorphous Silica) | 3 |
| imparting | Amino Resin | 13 |
| Agent | Solvent | 80 |
| | Additive | 4 |

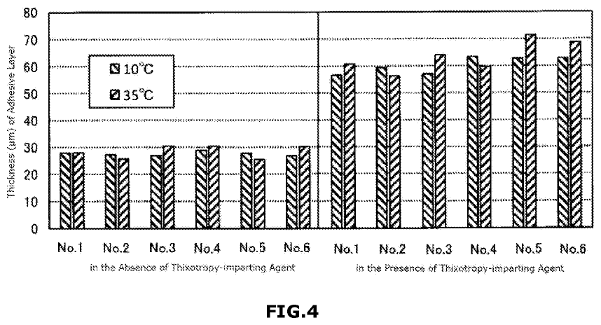

Each adhesive composition was sprayed onto the Epolamine-coated surface of the base material with a spray gun at two liquid temperatures of 10° C. and 35° C. After that, it was placed in a hot air dryer and heated at 150° C. for 20 minutes to form a coating layer and an adhesive layer. Six samples (Sample Nos. 1 to 6) each having the same adhesive composition and the same liquid temperature were produced. FIG. 4 shows the thicknesses of the formed adhesive layers. As shown in FIG. 4, in the case where the adhesive composition containing a thixotropy-imparting agent was used, at any liquid temperature, the thickness of the adhesive layer was at least double that in the case where the adhesive composition containing no thixotropy-imparting agent was used. In addition, there was a tendency that the adhesive composition at a higher liquid temperature had a slightly larger thickness.

### (2) Difference in Abrasion Amount due to the Presence and Absence of a Thixotropy-Imparting Agent

Adhesive layers with and without a thixotropy-imparting agent were formed, and the abrasion resistance properties of test pieces after flocking were examined.

### Production of Test Pieces

First, a zinc phosphate film was formed on a surface of a steel sheet, and it was then subjected to Epolamine coating in the same manner as the base material in the preceding Part (1). Next, each of two types of adhesive compositions with and without a thixotropy-imparting agent was sprayed onto the Epolamine-coated surface at a liquid temperature of 35° C. with a spray gun. The components of the coating material for Epolamine coating and of the adhesive compositions were shown in Tables 1 to 3 mentioned above. Next, flocking fillers were sprayed onto the surface coated with the adhesive composition using an electrostatic coating gun. As the flocking fillers, organic fillers made of nylon 66 fibers (20 μm in thickness, 800 μm in length, having an electrodeposition-treated film, and having a surface resistance value of 106 to 107 Ω) were used. After that, it was placed in a hot air dryer and heated at 150° C. for 10 minutes to form a coating layer and an adhesive layer. In this way, a test piece was produced in which a zinc phosphate film, a coating layer, an adhesive layer, and a flocking layer were formed on the surface of the steel sheet in sequence from the bottom. The thickness of the coating layer in the test piece was 25 μm. Two types of adhesive layers were formed with varying thicknesses. The thicknesses were 27 μm and 28 μm in the case where the adhesive composition containing no thixotropy-imparting agent was used, and the thicknesses were 53 μm and 60 μm in the case where the adhesive composition containing the thixotropy-imparting agent was used. Three test pieces were produced for each of the thicknesses of the adhesive layers.

Besides, a steel sheet in a state before flocking, that is, in a state where an adhesive composition was sprayed on its Epolamine-coated surface, was placed in a hot air dryer and heated at 150° C. for 10 minutes to form a coating layer and an adhesive layer. Then, the hardness of the surface of the formed adhesive layer was measured according to JIS K5600-5-4:1999 “Scratch Hardness (Pencil Method)”. As a result, the adhesive layer containing no thixotropy-imparting agent had a pencil hardness of H, and the adhesive layer containing the thixotropy-imparting agent had a pencil hardness of 3 H.

### Test Method

A Taber abrasion test was performed according to JIS K7204: 1999 “Plastic-Abrasion Wheel-based Abrasion Test Method” to measure the abrasion amounts of the test pieces. The test pieces were disc-shaped with a diameter of 100 mm, the abrasion wheel was CS10, and the rotational speed of the abrasion wheel was 72 rpm.

### Test Result

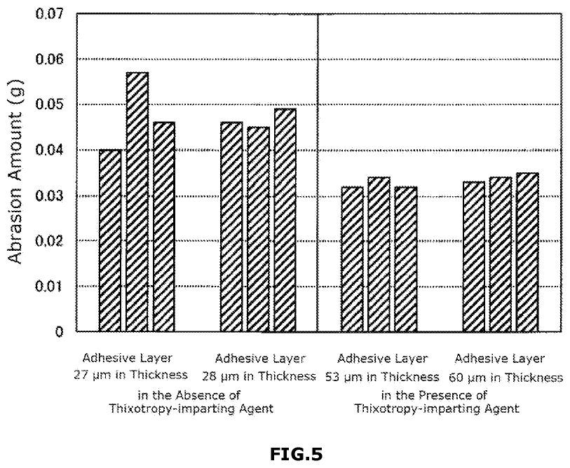

FIG. 5 shows the results of measurement of the abrasion amounts of the test pieces. As shown in FIG. 5, the abrasion amount was less when the adhesive composition containing the thixotropy-imparting agent was used. Conceivably, the reason for this was that there were a large number of fillers and they had high retention capability due to the large thickness of the adhesive layer, and friction with a counterpart member (the abrasion wheel in this abrasion test) decreased due to the increase in the number of upright fillers (decrease in the inclination ratio of the fillers), among others.

### (3) Evaluation of Flocked State

The implanted states of fillers were examined in the case where adhesive layers having various thicknesses with and without a thixotropy-imparting agent were formed on coil springs, and then they were subjected to flocking.

### Production of Flocked Spring

A zinc phosphate film, a coating layer, an adhesive layer, and a flocking layer were formed on the surface of a coil spring in sequence from the bottom in the same manner as in the preceding Part (2) to produce a flocked spring. Specifically, first, a zinc phosphate film was formed on a coil spring made of spring steel, and then it was subjected to Epolamine coating. Next, each of two types of adhesive compositions with and without a thixotropy-imparting agent were sprayed onto the Epolamine-coated surface at a liquid temperature of 35° C. with a spray gun. The components of the coating material for Epolamine coating and of the adhesive compositions were shown in Tables 1to 3 mentioned above. Next, the surface coated with the adhesive composition was sprayed with organic fillers made of nylon 66 fibers (same as above) using an electrostatic coating gun. After that, it was placed in a hot air dryer and heated at 150° C. for 10 minutes to form a coating layer and an adhesive layer. The coil spring used was dimensioned to have a wire diameter of 3.6 mm, an outer diameter of 27.5 mm, a free length of 724 mm, and a total number of turns of 57. The thickness of the coating layer in the flocked spring was 25 μm.

### Evaluation Method

The Evaluation in regard of the implanted state of fillers was performed by counting the number of fillers in a predetermined measurement area as follows. First, a medical scalpel was used to cut the surface layer along the surface of the flocked spring, and the cut surface was observed by an SEM. Then, the number of fillers in a measurement area of 1.2 mm² was counted. Next, the number of upright fillers, each having a cross section with a major axial length not more than 1.41 times the thickness of the fillers used, was counted. Then, the inclination ratio of the fillers was calculated by the above formula (II).

### Evaluation Result

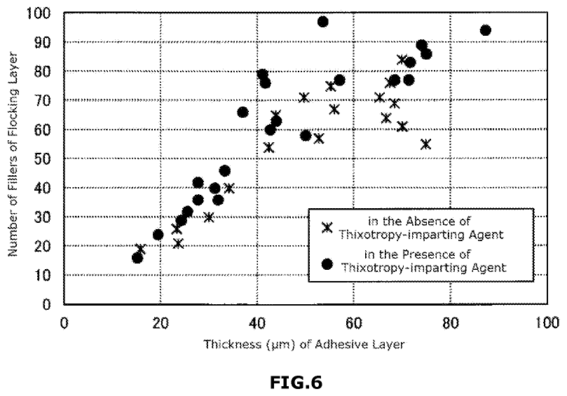

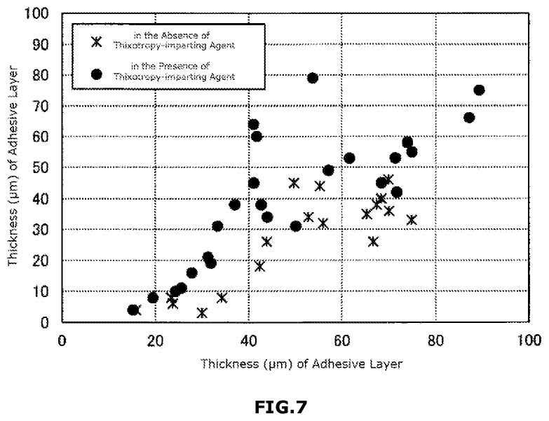

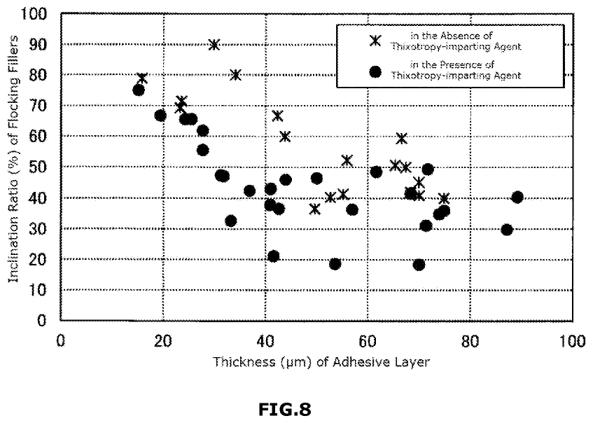

As an example, the result of evaluation of the implanted state on the inner side of the coil of the flocked spring is shown. FIG. 6 shows a graph plotting the number of fillers in relation to the thickness of the adhesive layer. FIG. 7 shows a graph plotting the number of upright fillers in relation to the thickness of the adhesive layer. FIG. 8 shows a graph plotting the inclination ratio of the fillers in relation to the thickness of the adhesive layer. As shown in FIG. 6, in the case where flocking was performed on the adhesive layer containing the thixotropy-imparting agent, the number of affixed fillers increased. In this case, the number of fillers increased even when the adhesive layer had a relatively thin thickness of 20 to 40 μm. In addition, as shown in FIGS. 7 and 8, the adhesive layer containing the thixotropy-imparting agent had a larger number of upright fillers and a lower inclination ratio of fillers.

### (4) Evaluation of Endurance

The seven flocked springs with different thicknesses of adhesive layers produced in the preceding Part (3) were each mounted to a spring assembly (see FIG. 1 above), and an endurance test was carried out in which the flocked springs were stretched and contracted 30,000 times in the upward/downward direction. After that, endurance was evaluated by examining the state of a guide member (inner cylinder). The guide member was made of iron and had a cylindrical shape, and its surface was coated by cationic electrodeposition. All the adhesive layers of the flocked springs were formed of an adhesive composition containing a thixotropy-imparting agent. Endurance was evaluated based on the degree of peeling of a coating material on the guide member, the endurance was evaluated to be excellent (indicated by the mark ◯ in Table 4 below) in a case where no peeling was observed, and endurance was evaluated to be somewhat poor (indicated by the mark Δ in the same table) in a case where partial peeling was observed. Table 4 shows the endurance evaluation results.

TABLE 4

| | Thickness (μm) of Adhesive Layer | | | | |
|---|---|---|---|---|---|
| | Outer Side of Coil | | Inner Side of Coil | | Endurance |
| Sample | Before | After | Before | After | (Inner |
| No. | Flocking | Flocking | Flocking | Flocking | Side) |
| No. 1 | 65 | 83 | 50 | 70 | ◯ |
| No. 2 | 60 | 88 | 45 | 62 | ◯ |
| No. 3 | 48 | 73 | 49 | 61 | ◯ |
| No. 4 | 51 | 80 | 42 | 58 | ◯ |
| No. 5 | 39 | 56 | 36 | 41 | ◯ |
| No. 6 | 47 | 66 | 25 | 29 | ◯ |
| No. 7 | 37 | 45 | 22 | 26 | Δ |

As shown in Table 4, in a case where the thickness of the adhesive layer on the inner side of the coil of the flocked spring was 29 μm or more, the coating on the guide member did not peel off and exhibited high endurance. However, in a case where the thickness of the adhesive layer was 26 μm, part of the coating on the guide member was peeled off.

### DESCRIPTION OF REFERENCE NUMERALS

1: spring assembly, 10: cover member, 100: spring seat, 20: guide member, 30: compression coil spring (flocked spring), 31: spring body, 32: coating layer, 33: adhesive layer, 330: surface of adhesive layer, 34: flocking layer.

1-8. (canceled)

9. A flocked spring comprising:
a coil spring body;
a coating layer arranged on a surface of the spring body;
an adhesive layer arranged on a surface of the coating layer; and
a flocking layer consisting of flocking fillers affixed to the adhesive layer,
wherein the adhesive layer is formed of an adhesive composition containing an adhesive and amorphous silica as a thixotropy-imparting agent, and
wherein in a case where a range of 1.2 mm² in the surface of the adhesive layer is set as a measurement area, there are 32 or more of the flocking fillers affixed to the measurement area.

10. The flocked spring according to claim 9, wherein in a case where a range of 1.2 mm² in the surface of the adhesive layer is set as a measurement area, among the flocking fillers affixed to the measurement area, there are 11 or more upright fillers affixed in a substantially upright state with respect to the surface of the adhesive layer.

11. The flocked spring according to claim 9, wherein in a case where a range of 1.2 mm² in the surface of the adhesive layer is set as a measurement area, the flocking fillers in the measurement area have an inclination ratio of 66% or less.

12. The flocked spring according to claim 10, wherein in a case where a range of 1.2 mm² in the surface of the adhesive layer is set as a measurement area, the flocking fillers in the measurement area have an inclination ratio of 66% or less.

13. The flocked spring according to claim 9, wherein the adhesive layer has a thickness of 25 μm or more and 90 μm or less.

14. The flocked spring according to claim 10, wherein the adhesive layer has a thickness of 25 μm or more and 90 μm or less.

15. The flocked spring according to claim 11, wherein the adhesive layer has a thickness of 25 μm or more and 90 μm or less.

16. The flocked spring according to claim 12, wherein the adhesive layer has a thickness of 25 μm or more and 90 μm or less.

17. The flocked spring according to claim 9, wherein the surface of the adhesive layer has a pencil hardness of 3 H or more.

18. The flocked spring according to claim 10, wherein the surface of the adhesive layer has a pencil hardness of 3 H or more.

19. The flocked spring according to claim 11, wherein the surface of the adhesive layer has a pencil hardness of 3 H or more.

20. The flocked spring according to claim 12, wherein the surface of the adhesive layer has a pencil hardness of 3 H or more.

21. The flocked spring according to claim 13, wherein the surface of the adhesive layer has a pencil hardness of 3 H or more.

22. The flocked spring according to claim 14, wherein the surface of the adhesive layer has a pencil hardness of 3 H or more.

23. The flocked spring according to claim 15, wherein the surface of the adhesive layer has a pencil hardness of 3 H or more.

24. The flocked spring according to claim 16, wherein the surface of the adhesive layer has a pencil hardness of 3 H or more.
